(19) United States
(12) Patent Application Publication
(10) Pub. No.: US 2024/0243315 A1
(43) Pub. Date: Jul. 18, 2024

(54) DUAL-STACK AIR-COOLED FUEL CELL

(71) Applicant: Shenzhen Polytechnic University, Shenzhen (CN)

(72) Inventors: Chen ZHAO, Shenzhen (CN); Fei WANG, Shenzhen (CN); Jingran ZHANG, Shenzhen (CN); Zhurong DONG, Shenzhen (CN)

(21) Appl. No.: 18/504,805

(22) Filed: Nov. 8, 2023

(30) Foreign Application Priority Data
Nov. 13, 2022 (CN) 202211416603.0

(51) Int. Cl. H01M 8/04746; H01M 8/04014; H01M 8/0432

(52) U.S. Cl. CPC H01M 8/04776; H01M 8/04014; H01M 8/04365; H01M 8/04768

(57) ABSTRACT

A dual-stack air-cooled fuel cell includes two stack groups, a fan assembly, an air supply channel, a spoiler and a temperature control device. The fan assembly is centrally located in the air-cooled fuel cell, and is configured to generate an air flow field in the air-cooled fuel cell. The two stack groups are located at an air inlet side and an air outlet side of the fan assembly, respectively. The spoiler is arranged between the fan assembly and the two stack groups. The above components are connected through the air supply channel. The temperature control device is configured to detect surface temperature of the stack groups to adjust the rotation direction of the fan assembly, so as to alternately perform suction and blowing operation for the two stack groups to reach the heat equilibrium of the fuel cell.

### CROSS-REFERENCE TO RELATED APPLICATIONS

This application claims the benefit of priority from Chinese Patent Application No. 202211416603.0, filed on Nov. 13, 2022. The content of the aforementioned application, including any intervening amendments thereto, is incorporated herein by reference in its entirety.

### TECHNICAL FIELD

This application relates to air-cooled fuel cells, and more particularly to a dual-stack air-cooled fuel cell and a preparation method thereof.

### BACKGROUND

In the operation of an air-cooled fuel cell, air is forced into a cathode channel by a cathode air supply system, which provides the reaction gas and also realizes the effects of dehumidification and air cooling. The traditional fan systems are often operated in a mode where only the flow disturbance at one side generated by “blowing” and “suction” operation of the fan is utilized, which results in low fan utilization efficiency, and is not conducive to improve working efficiency of the whole fuel cell and fully utilize the internal space.

### SUMMARY

It has been demonstrated that a working distance (i.e., a distance between the fan and an air-cooled fuel cell stack) and a blowing-suction mode of a fan will significantly affect an output performance of the stacks and distribution uniformity of the interior temperature. When the working distance of the fan is greater or less than an optimal working distance, the output performance of the stacks will decay. Compared to the blowing mode, the air flow rate and flow distribution are more uniform in the suction mode, which will be more conducive to the water and heat equilibrium, and control of electrochemical reaction rate in the stacks.

In view of the shortcomings of the prior art, the present disclosure provides a dual-stack air-cooled fuel cell, in which the fan flow field can be efficiently utilized, improving the overall net output power.

Technical solutions of the present disclosure are described as follows.

In a first aspect, this application provides a dual-stack air-cooled fuel cell, comprising:
a first stack;
a second stack;
an air inlet channel;
an air outlet channel;
a fan assembly;
a spoiler; and
a temperature control device;
wherein the fan assembly is centrally located at the dual-stack air-cooled fuel cell, and the fan assembly is configured as a power source that drives the whole air flow field, a mass transfer and a heat transfer of the first stack and the second stack; the air inlet channel is located at an air inlet side of the fan assembly, and the air outlet channel is located at an air outlet side of the fan assembly; the spoiler is arranged between the air outlet side and the air outlet channel, such that the fan assembly and an air supply channel jointly constitute a cathode air supply system of the dual-stack air-cooled fuel cell; the first stack is arranged at an air inlet of the air inlet channel, and the second stack is arranged at an air outlet of the air outlet channel. The above components are sealedly connected with each other and are connected to the stacks, so as to ensure the air in the cathode air supply system completely flows through a cathode channel of the stacks.

In an embodiment, the fan assembly is located between the first stack and the second stack. Air flows generated under the action of suction and blowing of two sides of the fan assembly flow through the first stack and the second stack of the cathode air supply system.

In an embodiment, the air inlet channel and the air outlet channel are both shrinking shape. A first end port of the air inlet channel and a first end port of the air outlet channel are matched and sealedly connected with a square stack. A second end port of the air inlet channel and a second end port of the air outlet channel are matched and sealedly connected a round fan flow channel.

In an embodiment, the first stack and the second stack are configured as a circular stack.

In an embodiment, the fan assembly is arranged on the cathode air supply system and near the first stack, therefore, a distance between the fan assembly and the first stack is less than a distance between the fan assembly and the second stack.

In an embodiment, a power of the first stack is greater than a power of the second stack, and a ratio of the power of the first stack to the power of the second stack is greater than 12:7.

In an embodiment, the cathode channel of the second stack includes a first sub-channel at a middle of the cathode channel and at least two second sub-channels on both sides of the cathode channel, and the at least two second sub-channels are narrower than the first sub-channel, which improves uneven distribution of a fluid generated by divergence characteristics of the fan assembly, and further enhances a performance of the second stack.

In an embodiment, the spoiler is arranged on an air blow side of the fan assembly. In this way, a blowing air flow enters the air supply channel after passes through the spoiler, which further plays a uniform role in the second stack.

In an embodiment, the spoiler includes a centrally-fixed ring, a first blade group and a second blade group. The first blade group and the second blade group are spirally and uniformly distributed in opposite directions. The first blade group and the second blade group are configured to disturb the air flow blown by the fan assembly to form a vortex flow, so as to improve a distribution uniformity of the air flow.

In an embodiment, the temperature control device includes a temperature sensor and a control unit. The temperature sensor is arranged on a surface of the first stack and is configured to monitor a surface temperature of the first stack. The control unit is configured to receive a temperature information from the temperature sensor to control a rotation direction of the fan assembly.

In a second aspect, this application provides a temperature control method for the dual-stack air-cooled fuel cell, comprising:
setting the temperature sensor to collect a surface temperature data of the first stack and the second stack;
setting a temperature lower limit and a temperature upper limit of the control unit to 40° C. and 80° C., respectively;
when the temperature sensor detects that a surface temperature of the first stack is higher than 80° C., receiving, by the control unit, the temperature information to control the fan assembly to rotate reversely, such that a flow direction of air in the cathode air supply system is turned by 180°, and the first stack is located on a downstream end of a flow field in the cathode air supply system; wherein under the influence of oxygen concentration and air humidity at the downstream end of the flow field, a workload of the first stack is reduced and is quickly cooled; and
when a temperature of the air inlet is cooled to 40° C. or below, controlling, by the control unit, the fan assembly to rotate forwardly again, such that the air-cooled fuel cell returns to an initial working mode; in this way, the fan assembly alternately performs the suction mode and the blowing mode for the first stack and the second stack to achieve a dynamic equilibrium of water and heat.

The present disclosure has the following beneficial effects.

The present disclosure provides a dual-stack air-cooled fuel cell, which has reduced size, improved utilization rate of the fan assembly and fewer balance-of-plant components, so as to improve a net output of the air-cooled fuel cell. Further, the fuel cell provided herein is further provided with a temperature control device to control a rotation direction of the fan assembly according to the detected temperature of the stacks, which realizes the alternate switching between the blowing mode and the suction mode, so as to arrive at a heat equilibrium of the stacks under a working temperature, avoid overheat damage, improve stack performance and prolong service life of the stack.

### BRIEF DESCRIPTION OF THE DRAWINGS

FIG. 1 is an exploded view of a dual-stack air-cooled fuel cell according to an embodiment of the present disclosure.

FIG. 2 is a general assembly view of the dual-stack air-cooled fuel cell shown in FIG. 1.

FIG. 3 is a general assembly view of an annular dual-stack air-cooled fuel cell according to an embodiment of the present disclosure.

FIG. 4 schematically shows a stack structure according to an embodiment of the present disclosure.

FIG. 5 schematically shows a cathode channel according to an embodiment of the present disclosure.

FIG. 6 schematically shows a structure of a spoiler according to an embodiment of the present disclosure.

FIG. 7 schematically shows a shell and an end cover according to an embodiment of the present disclosure.

### DETAILED DESCRIPTION OF EMBODIMENTS

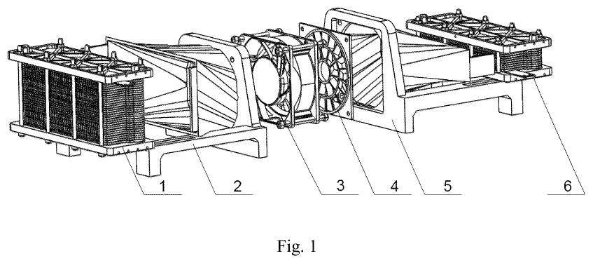

Referring to FIG. 1, the present disclosure provides a dual-stack air-cooled fuel cell, including a first stack 1, an air inlet channel 2, a fan assembly 3, a spoiler 4, an air outlet channel 5 and a second stack 6. The fan assembly 3 is centrally located at the whole air-cooled fuel cell. The air inlet channel 2 and the air outlet channel 5 are arranged on two sides of the fan assembly 3, respectively. The spoiler 4 is arranged between an air outlet side of the fan assembly 3 and the air outlet channel 5, such that the fan assembly 3 and the spoiler 4 jointly constitute a cathode air supply system of the air-cooled fuel cell. The first stack 1 is arranged on an air inlet of the cathode air supply system, and the second stack 6 is arranged on an air outlet of the cathode air supply system. The above components are sealedly connected with each other and are sealedly connected to the stacks, so as to ensure the air in the cathode air supply system completely flows through the first stack 1 and the second stack 6. A ratio of a power of the first stack 1 to a power of the second stack 6 is greater than 12:7. Compared to a blowing mode, the air flow rate and the flow distribution are more uniform under a suction mode of the fan assembly 3, which will be more conducive to water and heat equilibrium in the first stack 1 and the second stack 6, and control of electrochemical reaction rate. The first stack 1 can bear a higher power in the suction mode, while the second stack 6 is in the blowing mode, and can only bear a lower power. If the power of the second stack 6 is the same as the power of the first stack 1, the air cooling effect of the second stack 6 cannot meet the requirements, and an air cooling effect of the first stack 1 is also weakened. In this case, a utilization rate of the fan assembly 3 is not improved, and air cooling effects of the first stack 1 and the second stack 6 are also reduced. The fan assembly 3 is arranged such that a distance between the fan assembly 3 and the first stack 1 is less than a distance between the fan assembly 3 and the second stack 6. Based on relevant parameters of the stacks, such as an operating current, section number and an air stoichiometric ratio, the air flow rate of the fan assembly 3 is determined. The power of the first stack 1 is greater, and thus more air flow is needed for cooling. In view of this, the distance between the fan assembly 3 and the first stack 1 is set to be smaller, so as to satisfy the requirement of the first stack 1 for a greater air flow.

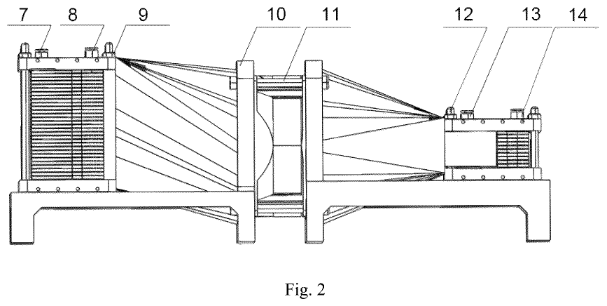

Referring to FIG. 2, a first temperature detection device 7 is arranged on a surface of the first stack 1, and a second temperature detection device 13 is arranged on a surface of the second stack 6, so as to monitor a temperature of the first stack 1 and the second stack 6. A collected temperature information is fed back to the fan assembly 3 after is processed by a control system to realize temperature control of the dual-stack air-cooled fuel cell. A first fuel inlet 8 is provided on the first stack 1, and a second fuel inlet 14 is provided on the second stack 6. The fuel enters a stack service pipe (not shown) through the first fuel inlet 8 and the second fuel inlet 14 and is evenly distributed to each cell unit. A first fastener 9 and a third fastener 12 apply assembly force on a first stack body and a second stack body to maintain their structure stability. A second fastener 11 is connected to the fan assembly 3, the spoiler 4, the air inlet channel 2 and the air outlet channel 5. The above components are arranged on and fixedly connected with a platform 10 to enhance a structure stability of the whole dual-stack air-cooled fuel cell.

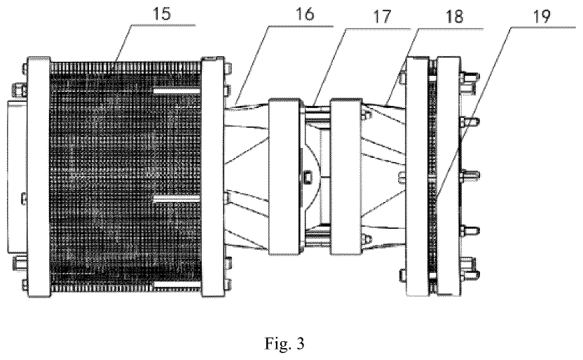

Referring to FIG. 3, the present provides an annular dual-stack air-cooled fuel cell, which is similar with the above dual-stack air-cooled fuel cell, including an inlet stack 15, an air inlet channel 16, a fan assembly 17, an air outlet channel 18 and an outlet stack 19. An annular cathode channel of the annular dual-stack air-cooled fuel cell is more suitable for an influence of the divergence characteristics of the fan assembly, which has a better performance in distribution uniformity of a fluid in the annular cathode channel and does not need to arrange the spoiler.

### Stack

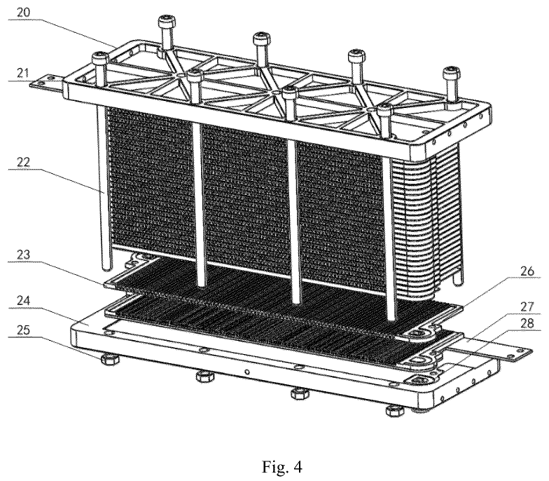

Referring to FIG. 4, the stacks generally each has a lamination structure. The stack bodies include a plurality of battery units 23 which is stacked, a cathode collector plate 21, an anode collector plate 27, a first end plate 20 and a second end plate 24. The first end plate 20 and the second end plate 24 are provided on two sides of the stack. Each of the plurality of battery units 23 includes a membrane exchange assembly (MEA), two adjacent sealing elements and two single-sided printed circuit board (PCB). The two single-sided PCB can be combined into a double-sided PCB. A fastening bolt 22 and a nut 25 are arranged on an outside of the lamination structure to apply the assembly force to maintain the structure stability of the stacks, and the assembly force is applied on the first end plate 20 and the second end plate 24. In an embodiment, the first end plate 20 and the second end plate 24 are made of polyester materials, which can be configured as an insulating plate to play an insulating role. In an embodiment, the first end plate 20 and the second end plate 24 are each provided with a reinforcement rib, which has a corresponding strength and stiffness, ensuring the assembly force is stable and is uniformly distributed on a platform of the air-cooled fuel cell. The plurality of battery units 23 are in series connection with each other. A third fuel inlet 28 is provided on the stack. The cathode collector plate 21 and the anode collector plate 27 are configured as output terminals to output a stack power to external load.

In an embodiment, the MEA, the double-sided PCB, the cathode collector plate 21 and the anode collector plate 27 are each provided with a location hole 26. A location rod (not shown) is added to the location hole 26 during an assembly of the stack. The MEA, the cathode collector plate 21, the anode collector plate 27 and other components are stacked together in opposite position following a position trajectory of the location rod. The appropriate assembly force is applied on the plurality of battery units to ensure an interior structure of the stack is stable without pressure loss, and meet requirements of sealing and contact with a resistance. The assembly force is designed mainly based on F_{sealing} and F_{MEA}. F_{sealing} represents an assembly force of the sealing elements, and F_{MEA} represents an assembly force of the MEA. F_{MEA} is determined by contact resistance experiments. A clearance height of the MEA and the sealing elements are the same after the stack is assembled, so that a deformation of the sealing elements and the F_{sealing} can be determined.

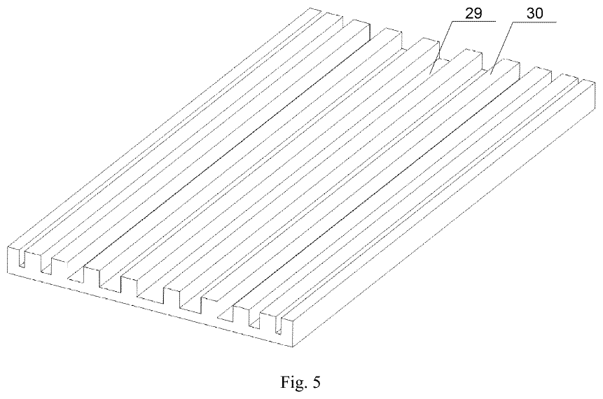

Referring to FIG. 5, in an embodiment, the cathode channel of the second stack includes a first sub-channel 29 at the middle of the cathode channel and at least two second sub-channels 30 on two sides of the cathode channel, and the at least two second sub-channels 30 are narrower than the first sub-channel 29, so as to improve uneven distribution of a fluid generated by divergence characteristics of the fan assembly, and further enhance a performance of the second stack.

### Spoiler

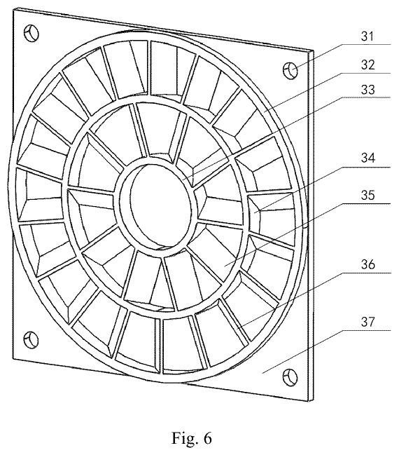

Referring to FIG. 6, the spoiler 4 includes a first fixing sleeve ring 33, a second fixing sleeve ring 34, a third fixing sleeve ring 32, a first blade group 35 and a second blade group 36. The first fixing sleeve ring 33, the second fixing sleeve ring 34 and the third fixing sleeve ring 32 are concentrically arranged. A radius of the first fixing sleeve ring 33, a radius of the second fixing sleeve ring 34 and a radius of the third fixing sleeve ring 32 are in increasing order. The first blade group 35 and the second blade group 36 are spirally and uniformly distributed in opposite directions between the first fixing sleeve ring 33, the second fixing sleeve ring 34 and the third fixing sleeve ring 32. A clearance between any adjacent blades of the first blade group 35 and the second blade group 36 and a central through hole of the first fixing sleeve ring 33 constitute a disturbance channel. An air flow blown by the fan assembly 3 is formed a vortex flow after passing through the disturbance channel. At the same time, a shock resistance of the air flow with the vortex flow is greatly increased, which obviously improves a heat exchange uniformity of the cathode channel in the blowing mode. A fixing end plate 37 of the spoiler, and a spoiler location hole 31 are configured to facilitate an installation of the spoiler.

### Shell and End Cover

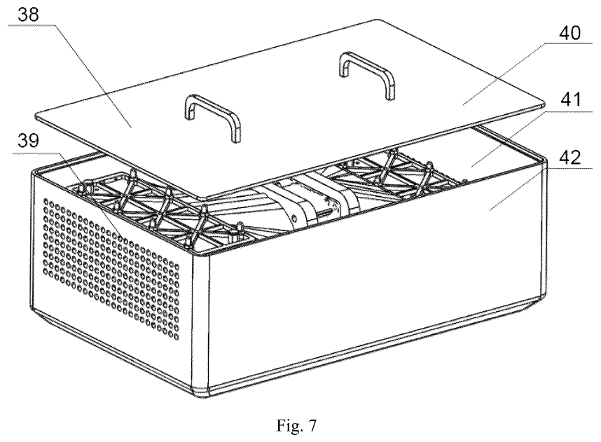

Referring to FIG. 7, in an embodiment, a shell 42 and an end cover 40 are configured to protect a stack structure of the dual-stack air-cooled fuel cell 41 and an air channel. Two ends of the shell 42 are each provided with a vent 39, and an ambient air enters the dual-stack air-cooled fuel cell through the vent 39. In an embodiment, a handle 38 is provided on the end cover 40, which is compatible with a compact structure of the air-cooled fuel cell.

The present disclosure has the following beneficial effects.
(1) The present disclosure provides a dual-stack air-cooled fuel cell, which has reduced size, improved utilization rate of the fan assembly and fewer balance-of-plant components, so as to improve a net output of the air-cooled fuel cell.
(2) The fuel cell provided herein is simply provided with a temperature control device to control a rotation direction of the fan assembly according to the detected temperature of the stacks, which realizes the alternate switching between the blowing mode and the suction mode, so as to arrive at a heat equilibrium of the stacks under a working temperature, avoid overheat damage, improve stack performance and prolong service life of the stack.

What is claimed is:

1. A dual-stack air-cooled fuel cell, comprising:
a first stack;
a second stack;
an air inlet channel;
a fan assembly;
an air outlet channel;
a spoiler; and
a temperature control device;
wherein the first stack is arranged at an air inlet of the air inlet channel, and the second stack is arranged at an air outlet of the air outlet channel; the fan assembly is located between the first stack and the second stack; the air inlet channel is connected with the first stack and a first side of the fan assembly, and the air outlet channel is connected with a second side of the fan assembly and the second stack; the fan assembly is configured to generate a suction effect at the first side and a blowing effect at the second side, such that an air flow is driven to pass through the first stack and the second stack in turn; the spoiler is arranged between the second side of the fan assembly and the air outlet channel; the temperature control device comprises a temperature sensor and a control unit; the temperature sensor is arranged on a surface of the first stack, and is configured to monitor a surface temperature of the first stack; and the control unit is configured to receive a temperature information from the temperature sensor and feed back a control signal to the fan assembly based on the temperature information, so as to control a rotation direction of the fan assembly.

2. The dual-stack air-cooled fuel cell of claim 1, wherein the dual-stack air-cooled fuel cell has a square or ring-shaped structure.

3. The dual-stack air-cooled fuel cell of claim 1, wherein the spoiler is arranged between the fan assembly and the air outlet channel; and the air flow is configured to be blown by the fan assembly to pass through the spoiler to enter an air supply channel, so as to act on the second stack.

4. The dual-stack air-cooled fuel cell of claim 1, wherein a distance between the fan assembly and the first stack is less than a distance between the fan assembly and the second stack.

5. The dual-stack air-cooled fuel cell of claim 1, wherein a power of the first stack is greater than a power of the second stack, and a ratio of the power of the first stack to the power of the second stack is greater than 12:7.

6. The dual-stack air-cooled fuel cell of claim 1, wherein a cathode channel of the second stack comprises a first sub-channel at a middle of the cathode channel and at least two second sub-channels on both sides of the cathode channel; and the at least two second sub-channels are narrower than the first sub-channel.

7. The dual-stack air-cooled fuel cell of claim 3, wherein the spoiler comprises a first fixing sleeve ring, a second fixing sleeve ring, a third fixing sleeve ring, a first blade group and a second blade group; the first fixing sleeve ring, the second fixing sleeve ring and the third fixing sleeve ring are concentrically arranged; the first blade group and the second blade group are spirally and uniformly distributed in opposite directions; the first blade group is distributed between the first fixing sleeve ring and the second fixing sleeve ring, and the second blade group is distributed between the second fixing sleeve ring and the third fixing sleeve ring; and the first blade group and the second blade group are configured to disturb the air flow blown by the fan assembly to form a vortex flow.

8. The dual-stack air-cooled fuel cell of claim 1, wherein a temperature lower limit and a temperature upper limit of the control unit are set to 40° C. and 80° C., respectively;
when the temperature sensor detects that the surface temperature of the first stack is higher than 80° C., the control unit is configured to control the fan assembly to rotate reversely to reverse a direction of the air flow, such that the first stack is changed from being located at an upstream end of the air flow to being located at a downstream end of the air flow; and
when a temperature of the air inlet is lowered to 40° C. or below, the control unit is configured to control the fan assembly to rotate forwardly again; in this way, the fan assembly is configured to alternately perform a suction mode and a blowing mode for the first stack and the second stack to achieve a dynamic water and heat equilibrium between the first stack and the second stack.

9. The dual-stack air-cooled fuel cell of claim 1, wherein the temperature sensor is also configured to detect a surface temperature of the second stack; and a temperature lower limit and a temperature upper limit of the control unit are set to 40° C. and 80° C., respectively;
when the temperature sensor detects that the surface temperature of the first stack is higher than 80° C., the control unit is configured to control the fan assembly to rotate reversely to reverse a direction of the air flow, such that the first stack is changed from being located at an upstream end of the air flow to being located at a downstream end of the air flow; because an oxygen concentration is lower and the air humidity is higher at the downstream end of the air flow, a working load of the first stack is reduced, so that heat generation of the first stack decreases and a temperature of the first stack drops faster; and
when a temperature of the air inlet is lowered to 40° C. or below, the control unit is configured to control the fan assembly to rotate forwardly again; in this way, the fan assembly is configured to alternately perform a suction mode and a blowing mode for the first stack and the second stack to achieve a dynamic water and heat equilibrium between the first stack and the second stack.
